(19) United States
(12) Patent Application Publication
(10) Pub. No.: US 2015/0225265 A1
(43) Pub. Date: Aug. 13, 2015

(54) FUNCTIONAL WATER GENERATOR

(71) Applicant: Sharp Kabushiki Kaisha, Osaka-shi, Osaka (JP)

(72) Inventors: Kentaro Terashima, Osaka-shi (JP); Shohzoh Tanaka, Osaka-shi (JP); Seiji Tanahashi, Osaka-shi (JP); Masakazu Tanahashi, Osaka-shi (JP)

(21) Appl. No.: 14/425,368

(22) PCT Filed: Sep. 3, 2013
(86) PCT No.: PCT/JP2013/073605

§ 371 Date: Mar. 3, 2015

(30) Foreign Application Priority Data
Sep. 7, 2012 (JP) 2012-197893
Sep. 7, 2012 (JP) 2012-197896
Nov. 21, 2012 (JP) 2012-255094

(51) Int. Cl. C02F 1/461; C02F 1/46

(52) U.S. Cl. CPC C02F 1/4618; C02F 1/4602; C02F 2001/46119

(57) ABSTRACT

A functional water generator capable of making best use of functional water generated in an electrolysis vessel is provided.

An electrolysis unit 4 formed of a positive electrode and a negative electrode is disposed in the electrolysis vessel 1, the functional water is generated by electrolyzing water W supplied into the electrolysis vessel 1 using the electrolysis unit 4, then when the functional water is discharged from a discharge unit 3 of the electrolysis vessel 1, the functional water remains in the electrolysis vessel 1 such that at least a part of the positive electrode and a part of the negative electrode are immersed, and a current in a direction opposite to that at the time of generating the functional water flows through the electrodes of the electrolysis unit 4, and thus electrode cleaning is performed in which a hardness component attached to the electrodes at the time of generating the functional water is eluted into the water, and the positive electrode and the negative electrode are arranged to face each other in parallel in a vertical direction.

### TECHNICAL FIELD

The present invention relates to a functional water generator which generates functional water by using an electrolysis unit formed of a positive electrode and a negative electrode.

### BACKGROUND ART

In an ion concentration adjustment device using an electric duplex layer of the related art, a voltage is applied between an ion adsorption electrode for positive ions and an ion adsorption electrode for negative ions, and ions in water are moved, and thus an amount of ions is controlled, and water softening and water hardening are performed (refer to PTL 1).

However, in the ion concentration adjustment device described above, when an applied voltage for increasing an adsorption speed increases, ions of an electric duplex layer are fixed to a surface of the ion adsorption electrode, and it is difficult to perform adsorption, and attachment and detachment with respect to the ions, and thus it is not possible to increase and decrease only a hardness component.

In addition, in another example of the related art, when an electrolysis unit electrolyzes water and prepares functional water, the electrolysis is performed by using a platinum electrode on a positive electrode side, and a carbon electrode on a negative electrode side, and oxygen is generated on the positive electrode side (isolated hydrogen ions are eluted into water), and the pH of a solution is decreased (is acidified).

In this case, when tap water is used as the water for electrolysis, a hardness component such as Ca ions or Mg ions is adsorbed onto the carbon electrode on the negative electrode side. Accordingly, it is possible to decrease a concentration of the Ca ions or the Mg ions included in the obtained water after the electrolysis (the functional water), and by using the obtained functional water in an air spray type humidifying device, it is possible to prevent a calcium salt or a magnesium salt from being attached to house furnishings or window glass. In addition, by using the functional water in a heating type humidifying device, it is possible to prevent the hardness component from being accumulated in a humidifying filter as a scale.

On the other hand, when the electrolysis is constantly performed by using the carbon electrode in the negative electrode, a surface of the carbon electrode is covered with the hardness component, and an adsorption capacity of the ion adsorption electrode is eliminated, and thus finally, desired electrolysis is not able to be performed. For this reason, a polarity of the electrode is suitably reversed, and the hardness component is eluted (refer to PTL 2).

### CITATION LIST

### Patent Literature

PTL 1: Japanese Patent No. 3994418

PTL 2: Japanese Unexamined Patent Application

### Publication No. 2010-117080

### SUMMARY OF INVENTION

### Technical Problem

However, in PTL 2, the electrode for electrolysis is arranged in a state where an electrode surface is erected in a vertical direction in a lower portion of a water supply tank, and thus when the entire electrode is cleaned, it is necessary to make the functional water remain by an amount equal to a height of the electrode, and an amount of functional water which is able to be used is decreased by that amount.

Therefore, an object of the present invention is to provide a functional water generator which is able to make best use of functional water generated in an electrolysis vessel and is highly convenient.

### Solution to Problem

In order to solve the problems described above, a functional water generator according to the present invention includes an electrolysis unit which is formed of a positive electrode and a negative electrode, and is disposed in an electrolysis vessel, in which the electrolysis unit electrolyzes water supplied into the electrolysis vessel and generates functional water, then when the functional water is discharged from a water drain port of the electrolysis vessel, the functional water remains in the electrolysis vessel such that both of the positive electrode and the negative electrode are immersed, and a current flows through the electrodes of the electrolysis unit in a direction opposite to that at the time of generating the functional water, and thus electrode cleaning is performed in which a hardness component attached to the electrodes at the time of generating the functional water is eluted into the water, and the positive electrode and the negative electrode are arranged to face each other in parallel in a vertical direction.

That is, in the present invention, the positive electrode and the negative electrode of the electrolysis unit (hereinafter, simply referred to as an “electrode”) are laterally laid such that an electrode surface is directed toward a horizontal direction, and the positive electrode and the negative electrode are arranged to face each other having a set distance in the vertical direction, and thus a thickness direction of the electrode is the vertical direction, and a volume of the electrolysis vessel occupied by the electrolysis unit decreases compared to a case where the electrode is erected. Therefore, when the electrode is cleaned, it is possible to decrease an amount of remaining functional water.

Here, the functional water indicates acidic water obtained by the electrolysis. In addition, “both the positive electrode and the negative electrode are immersed” indicates that at least a part of the electrodes is immersed in the functional water such that energization is able to be performed between the positive electrode and the negative electrode. In addition, it is preferable that the entirety of electrodes is immersed in the functional water in order to efficiently elute the hardness component attached to the entire electrode.

Furthermore, the electrode of the electrolysis unit may be configured of a subject matter which is not dissolved by the electrolysis. Specifically, it is possible to use a metal electrode in which the electrolysis easily occurs on a surface as the positive electrode at the time of generating the functional water, and it is possible to use an electrode on which ions are able to be adsorbed as the negative electrode. As the metal electrode, it is possible to use an electrode having platinum on a surface thereof, and specifically, it is possible to use a platinum electrode or a metal electrode (for example, titanium) which is coated with platinum. Accordingly, oxygen gas is ejected at the time of generating the functional water, and remaining hydrogen ions are isolated and acidified in the water.

On the other hand, it is possible to use a carbon electrode formed of a conductive carbon material (for example, carbon fiber, activated carbon, or the like) as an ion adsorption electrode of the negative electrode, and among them, it is preferable to use activated carbon of which a specific surface area adsorbing the ions is large in at least a part of the carbon electrode. In the activated carbon electrode, it is possible to effectively adsorb the hardness component such as Mg ions or Ca ions which are dissolved in the water such as tap water by using a porous adsorption surface of the activated carbon electrode, and even when the activated carbon electrode is used over time, and the adsorption surface of the activated carbon electrode is clogged by the hardness component and is not able to be reproduced, the activated carbon electrode is comparatively low in price compared to platinum, and thus it is possible to easily return the activated carbon electrode to an initial state by exchanging the activated carbon electrode.

The electrode of the electrolysis unit may be arranged such that the positive electrode (the metal electrode) at the time of generating the functional water is arranged above the negative electrode (the carbon electrode). Accordingly, the positive electrode generating the oxygen gas is arranged further on the upper side than the negative electrode, and thus the oxygen gas is not accumulated in the negative electrode, and it is possible to efficiently perform the electrolysis. In addition, by arranging the positive electrode on the upper side, acid-alkali ions (at the time of electrolysis: H+ ions, and at the time of electrode cleaning: OH⁻ ions) which are generated at the same time of generating the gas are efficiently generated, and it is possible to stabilize a concentration of the functional water in the electrolysis vessel by performing convection in a solution.

However, the water is mainly electrolyzed by the positive electrode, and thus the hydrogen ions generated at the time of generating the functional water are diffused in an upper portion and a lower portion of the positive electrode, and a loss in efficiency of the electrolysis increases. In addition, when the functional water is generated, the hardness component is adsorbed onto the negative electrode, but when an amount of water between the positive electrode and the negative electrode decreases, and it is difficult to adsorb the hardness component from the entirety of water contained in the electrolysis vessel when the functional water is electrolyzed.

As a unit for solving the problem described above, the positive electrode is movable in an up and down direction following a water surface in the electrolysis vessel. In this case, in order to maintain a state where the entire electrode is constantly immersed in the water, the positive electrode may be moved following a change in the water level to be positioned in the vicinity of a lower side of the water surface (a lower side from the water surface by 1 mm to 10 mm).

The position of the positive electrode is movable in the up and down direction following the water surface by disposing a driving mechanism in a positive electrode end portion, and thus it is possible to adsorb the hardness component from the entirety of water contained in the electrolysis vessel when the functional water is electrolyzed, and it is possible to sufficiently decrease hardness of the functional water. In addition, the water is mainly electrolyzed by the positive electrode, and thus it is possible to diffuse the hydrogen ions generated at the time of generating the functional water only in a down direction of the positive electrode, and it is possible for the hydrogen ions generated in the positive electrode to be involved in conduction between the positive electrode and the negative electrode and to decrease a voltage (increase electric conductivity), and thus it is possible to improve efficiency of the electrolysis.

In addition, as another unit for moving the positive electrode in the up and down direction, the positive electrode may be moved in the up and down direction following the water surface in the electrolysis vessel by attaching a float to the positive electrode of the electrolysis unit.

By attaching the float to the positive electrode, it is possible to constantly maintain the positive electrode to be positioned downwardly away from the water surface by a certain distance without using a special driving mechanism. Accordingly, it is possible to adsorb the hardness component from the entirety of water contained in the electrolysis vessel when the water is electrolyzed. Accordingly, it is possible to minimize a loss in efficiency of the electrolysis.

In addition, both the electrode surfaces are directed toward the horizontal direction, and thus the oxygen gas is easily accumulated on a lower surface side of the positive electrode. Therefore, in order to maintain excellent efficiency of the electrolysis by preventing air bubbles of oxygen from being attached to the electrode surface, it is preferable to combinedly use a device such as a stirrer stirring the water in the electrolysis vessel, or an air bubble removing device removing the air bubbles attached to the electrolysis unit such as a device vibrating or oscillating the electrode of the electrolysis unit or an ultrasonic vibrator.

As described above, when it is possible to remove the air bubbles from the electrode surface in the electrolysis vessel, the negative electrode (the carbon electrode) at the time of generating the functional water may be arranged above the positive electrode (the metal electrode). Accordingly, it is possible to directly clean the carbon electrode with cleaning water, and it is possible to more effectively remove an alkali water component remaining on a negative electrode surface or the hardness component.

In addition, a main body unit retaining the electrolysis vessel to be attachable and detachable may be disposed, and the water drain port may function as a water supply port for supplying the water into the electrolysis vessel in a state where the electrolysis vessel is detached from the main body unit.

That is, in the configuration described above, the water drain port is directed upward at the time of supplying the water and functions as the water supply port, and thus the positive electrode and the negative electrode of the electrolysis unit are in an erected state, and it is possible to perform stable water supply in which the water is rarely spilt due to hand shaking or the like. In addition, after cleaning the electrode, in the state where the electrolysis vessel is detached from the main body unit, the water drain port is directed downward and functions as a waste water port when remaining water in which the hardness component is dissolved is removed. At this time, the positive electrode and the negative electrode of the electrolysis unit are in the erected state, and the remaining water is directed toward the water drain port and flows along the electrode surface, and thus it is possible to effectively remove the hardness component which is still attached to the electrode surface.

In the functional water generator having the configuration described above, the functional water discharged from the discharge unit is able to be directly used, and a diffusion unit ejecting the functional water into the air in the form of mist or steam may be included. By diffusing the functional water in the air, it is possible to perform humidification, and it is possible to prevent the hardness component from being attached to house furnishings or window glass.

In particular, when a mist generation device atomizing the functional water is used as the diffusion unit, the functional water which is acidic water is atomized, and thus it is possible to spray the functional water into a space or onto a human body without a fluctuation in the pH of the functional water, and when the functional water is sprayed into the space, it is possible to preferably use the functional water for air cleaning or humidifying such as prevention of bacterial infection due to a sterilizing effect of the functional water. In addition, when the functional water is sprayed onto skin or the like, it is possible to preferably use the functional water for aesthetics such as a sterilization effect due to an astringent effect, activation of skin or the like, and a tightening effect of skin.

### Advantageous Effects of Invention

As described above, according to the present invention, the positive electrode and the negative electrode of the electrolysis unit are arranged to face each other in parallel in the vertical direction, and thus it is possible to use the maximum amount of functional water generated in the electrolysis vessel.

### BRIEF DESCRIPTION OF DRAWINGS

FIG. 1 is a schematic view illustrating a configuration of a functional water generator in an embodiment of the present invention, and illustrates a state where an electrolysis vessel is filled with water.

FIG. 2 is a diagram illustrating a state where the functional water generated by electrolysis is introduced into a diffusion unit in the functional water generator.

FIG. 3 is a schematic view for illustrating a reaction at the time of the electrolysis in the functional water generator described above.

FIG. 4 is a schematic view for illustrating a reaction at the time of electrode cleaning in the functional water generator of FIG. 3.

FIG. 5 is a perspective view of a schematic configuration of an electrolysis unit.

FIG. 6 is a diagram illustrating a state where alkali water generated after the electrode cleaning is introduced into an alkali water storage unit in a functional water generation device using an electrolysis unit of another aspect.

FIG. 7 is a schematic view for illustrating an operation of the functional water generator of the present invention.

FIG. 8 is a schematic view illustrating a second embodiment of the functional water generator, and illustrates a state where the electrolysis vessel is filled with the water.

FIG. 9 is a schematic view illustrating a state where the functional water generated by the electrolysis is introduced into the diffusion unit in the functional water generation device of FIG. 8.

FIG. 10 is a graph illustrating a relationship between a pH value and an electrolysis time when a current or a set distance between the electrodes is changed in the electrolysis.

FIG. 11 is a diagram illustrating a third embodiment of the functional water generator.

FIG. 12 is a schematic view illustrating a configuration of the functional water generator in a fourth embodiment of the present invention, and illustrates a state where the electrolysis vessel is filled with the water.

FIG. 13 is a diagram illustrating a state where the functional water generated by the electrolysis is introduced into the functional water storage unit in the functional water generator.

FIG. 14 is a diagram illustrating a state where the alkali water generated after the electrode cleaning is introduced into the alkali water storage unit in the functional water generator.

FIG. 15 is a schematic view for illustrating the operation of the functional water generator of the present invention.

### DESCRIPTION OF EMBODIMENTS

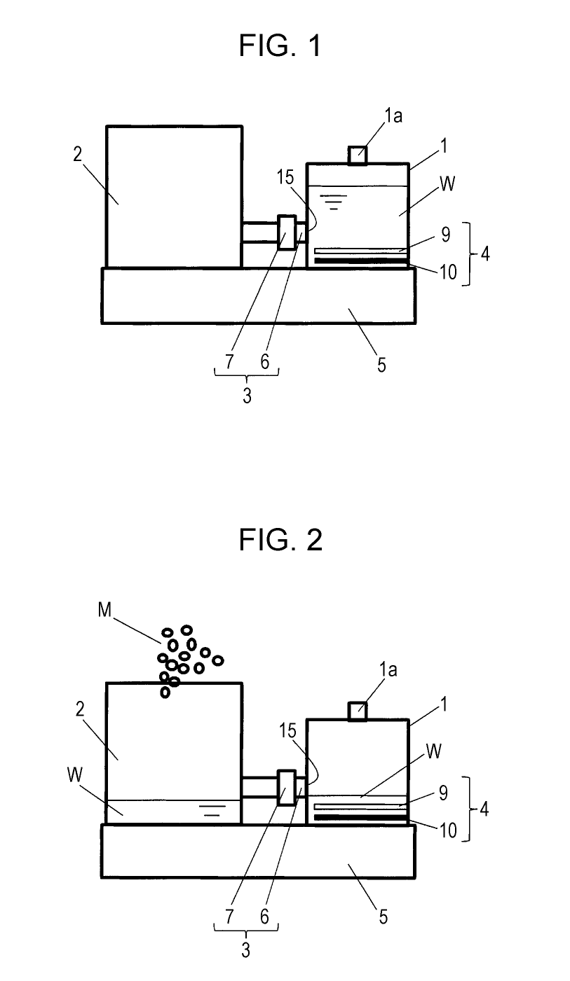

Hereinafter, embodiments of the present invention will be described with reference to the drawings. FIG. 1 is a diagram illustrating a configuration of a functional water generator according to the present invention, and is a schematic view illustrating a state where water is supplied into an electrolysis vessel. FIG. 2 is a schematic view illustrating a state where generated functional water is drained from the electrolysis vessel and is introduced into a diffusion unit in the functional water generator of FIG. 1.

The functional water generator of the present invention is a one-tank type functional water generator, and includes an electrolysis vessel 1 which electrolyzes water W and generates functional water, a diffusion unit 2 which diffuses the functional water into the air, a discharge unit 3 which couples a water drain port 15 to a diffusion unit 2 of the electrolysis vessel 1 and introduces the functional water into the diffusion unit 2 from the electrolysis vessel 1, an electrolysis unit 4 disposed in the electrolysis vessel 1, and a main body unit 5 to which the electrolysis vessel 1 and the diffusion unit 2 are detachably attached.

The discharge unit 3 includes a pipe 6 coupling the water drain port 15 to the diffusion unit 2, and a switching valve 7 which is disposed in the middle of a pipe 5, and the water W in the electrolysis vessel 1 is able to be drained. In a lower portion inside the electrolysis vessel 1, the electrolysis unit 4 is disposed. The electrolysis unit 4 includes a platinum electrode 9 as a positive electrode at the time of generating the functional water, and a carbon electrode 10 as a negative electrode. Furthermore, it is preferable that the electrolysis unit 4 is disposed in the electrolysis vessel 1 to be attachable and detachable by unitizing the platinum electrode 9 and the carbon electrode 10 from a point of easy maintenance and electrode exchange.

As described above, in the functional water generator of the present invention, the electrolysis vessel 1 is attachable and detachable with respect to the main body unit 5, and thus after cleaning the electrode, it is possible to easily drain remaining water in the vessel without moving the main body unit 5. Accordingly, it is possible to simplify user maintenance. In addition, when the cleaning is performed, unnecessary water is prevented from being applied to the main body unit 5 or the like, and thus it is possible to prevent a malfunction due to a short circuit. Furthermore, in order to obtain electric contact at the time of attachment and detachment, a contact point is disposed on both of the electrolysis vessel 1 side and main body unit 5 side, and thus electric contact is obtained.

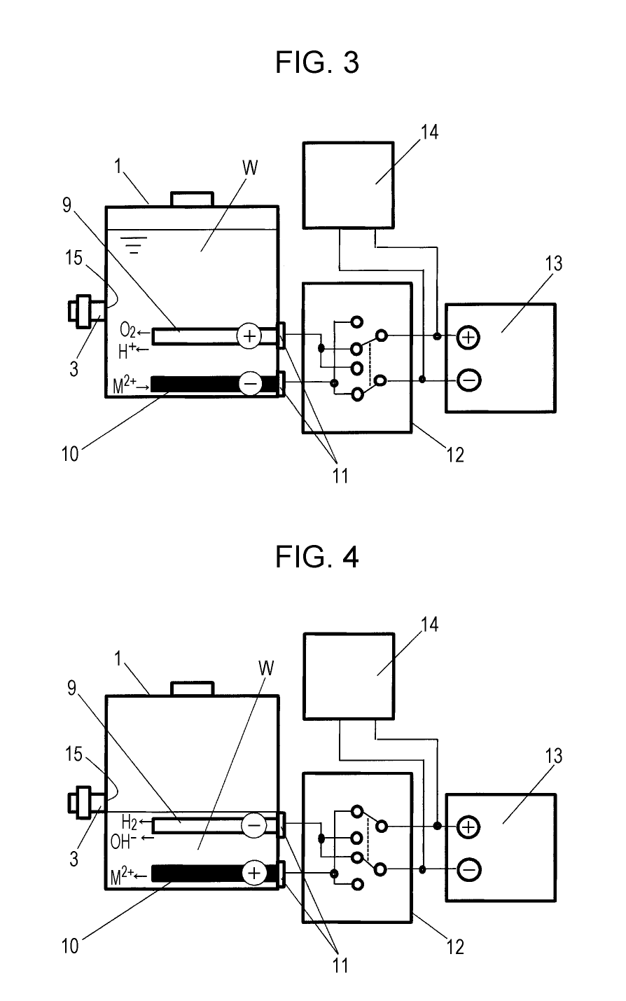

Specifically, as illustrated in FIG. 3 and FIG. 4, a contact electrode 11 for energizing the platinum electrode 9 of the electrolysis vessel 1 and the carbon electrode 10 in a state of being mounted on the main body unit 5 is disposed in the main body unit 5. A constant current generation source 13 is coupled to the contact electrode 11 through a switching circuit 12. A direction of a current supplied to the contact electrode 11 is switched and controlled in a control device 14. The control device 14 is configured of a microcomputer, controls a current amount and the direction of the current supplied to the electrolysis unit 4, and also controls switching of the switching valve 7, driving of the diffusion unit 2, or the like.

Both the platinum electrode 9 and the carbon electrode 10 are formed in a flat plate, and the platinum electrode 9 and the carbon electrode 10 are arranged to face each other in parallel in a vertical direction having a set distance. In this embodiment, the platinum electrode 9 is arranged further on an upper side than the carbon electrode 10.

The water drain port 15 is disposed on a higher position than the electrolysis unit 4, that is, on a higher position than an upper surface of the platinum electrode 9. Accordingly, even when the switching valve 7 is opened, and the water W in the electrolysis vessel 1 is drained from the water drain port 15, as illustrated in FIG. 2, the platinum electrode 9 and the carbon electrode 10 are maintained in a state where the entire platinum electrode 9 and the entire carbon electrode 10 are immersed in the water W.

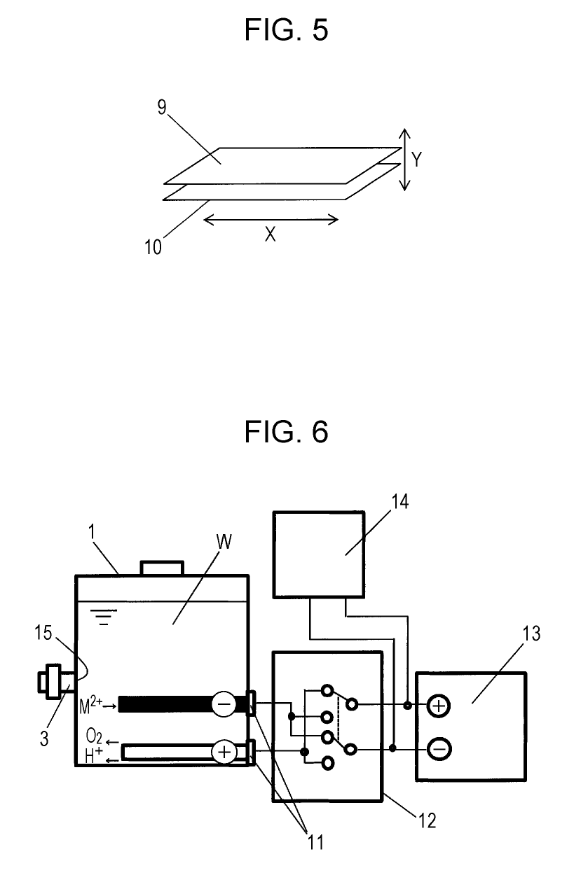

At this time, as illustrated in FIG. 5, the platinum electrode 9 and the carbon electrode 10 are laterally laid, an electrode surface is directed to a horizontal direction X, and both the electrodes 9 and 10 are arranged to face each other in a vertical direction Y having a set distance, and thus a volume of the electrolysis vessel occupied by the electrolysis unit 4 decreases compared to a state where the surface of the electrodes 9 and 10 is erected toward the vertical direction Y.

Therefore, when water remains by an amount of maintaining the state where the entire platinum electrode 9 and the entire carbon electrode 10 are immersed in the water W, and the other water is drained, an amount of drainage water may increase. Furthermore, in the present invention, the electrode surface is directed toward the horizontal direction X, but the electrode surface may be in a state of being slightly inclined with respect to the horizontal direction insofar as the electrode surface is laterally laid compared to the state where the electrode surface is erected toward the vertical direction, and thus a volume of the electrolysis unit decreases.

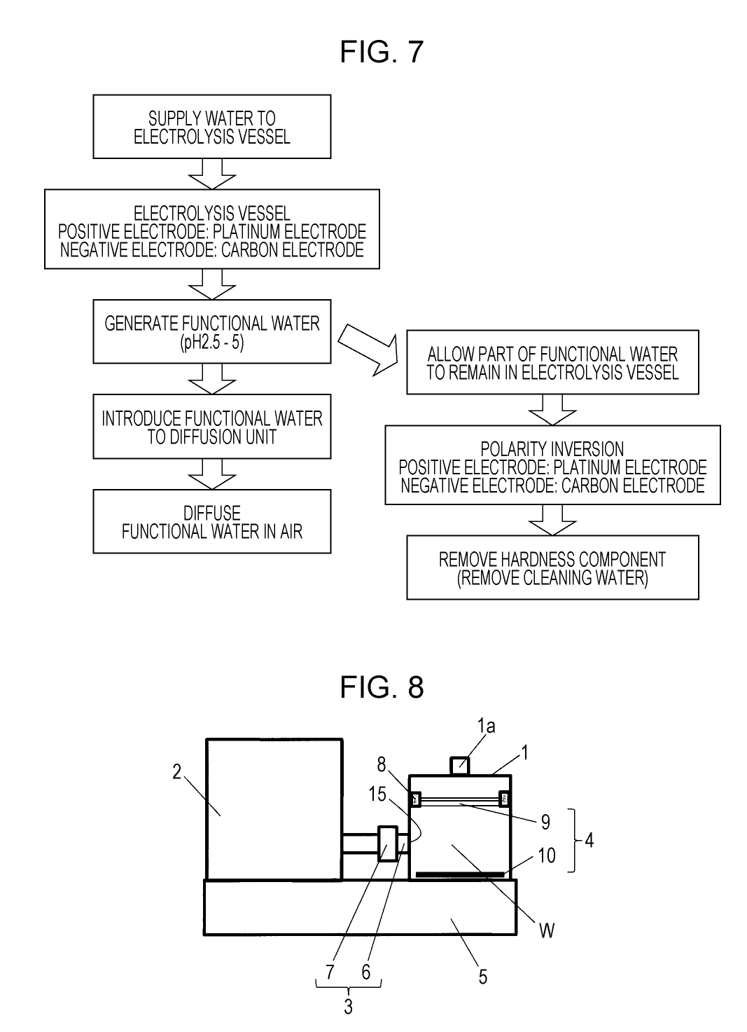

An operation of the functional water generator having the configuration described above will be described. FIG. 7 is a diagram for illustrating schematic operation contents of the functional water generator. First, the water W is supplied from a water supply port 1a into the one-tank type electrolysis vessel 1. As the water W to be used, normal tap water is able to be used. Specifically, for example, at the time of using tap water of Yao City in Osaka Prefecture (pH=7.5, hardness of approximately 50 mg/L), when a current in a current value: 500 mA, an electrode size: 150 mm×100 mm, and a set distance between electrodes: 15 mm is applied to 500 mL of water, it is possible to perform electrolysis at a voltage value which is comparatively low such as a voltage value of less than or equal to 30 V.

Accordingly, it is possible to reduce the running cost of the user. Furthermore, the tap water is able to be independently used, and as necessary, an electrolysis additive agent such as KCl or NaCl may be added to the tap water by approximately 0.1 wt % to 1 wt %, and thus the electrolysis may be promoted (the voltage value may be decreased).

In a state where the electrolysis vessel 1 is filled with the water and the electrodes 9 and 10 of the electrolysis unit 4 are immersed in the water, the electrolysis is performed. The electrolysis is performed, as illustrated in FIG. 3, by setting the platinum electrode 9 as a positive electrode, and the carbon electrode 10 as a negative electrode. The functional water generated by the electrolysis is acidified. Specifically, when an amount of water to be electrolyzed is 500 ml, the electrolysis is performed for 4 minutes in 500 mA, an electrode size: 150 mm×100 mm, and a set distance between electrodes: 15 mm, and thus acidic functional water of which the pH is approximately 3.0 to 3.2 is obtained.

Furthermore, in the functional water generator of this embodiment, the electrolysis is performed in a batch system. The batch system indicates that the electrolysis is performed without substantially moving the water in the electrolysis vessel after adding a predetermined amount of water to the electrolysis vessel.

At the time of the electrolysis, oxygen gas is ejected from the platinum electrode 9 which is the positive electrode, and remaining hydrogen ions are isolated in the water, and thus acidification is performed as shown in the following reaction formula (1).

2H₂O→O₂↑+4H⁻+4e⁻ Formula (1)

On the other hand, in the carbon electrode 10 which is the negative electrode, a hardness component such as Mg ions or Ca ions dissolved in the water such as the tap water is effectively adsorbed as ions of an electric duplex layer by using a porous adsorption surface of the carbon electrode as shown in the following reaction formula (2).

M²⁺+2e³¹ →M Formula (2)

Furthermore, in this embodiment, as illustrated in FIG. 3 and FIG. 5, the platinum electrode 9 is arranged further on the upper side than the carbon electrode 10, and thus even when the oxygen gas is generated from the platinum electrode 9 by the electrolysis, the generated oxygen gas is not attached to the carbon electrode 10, and the electrolysis is not inhibited. On the other hand, the oxygen gas is easily accumulated on a lower surface side of the platinum electrode.

Therefore, in order to more efficiently perform the electrolysis, it is possible to make it difficult for gas to be accumulated by disposing a slit in the platinum electrode, by arranging a plurality of stripe-like platinum electrodes in the horizontal direction having a set distance, or by forming a mesh-like platinum electrode, and it is possible to effectively perform convection with respect to acid-alkali ions generated on the platinum electrode in an upper portion and a lower portion of the platinum electrode. Further, when an air bubble removing device removing air bubbles attached to the electrolysis unit such as a device stirring the water in the electrolysis vessel, a device vibrating or oscillating the electrode of the electrolysis unit, or an ultrasonic vibrator is used, an area of the water which is in contact with the electrodes 9 and 10 increases, and the water in the electrolysis vessel is homogenized, and thus it is possible to more efficiently perform the electrolysis.

In addition, in order to efficiently perform the convection with respect to the water in the electrolysis vessel 1, it is preferable that a set distance of at least 5 mm is opened between end portions of the electrodes 9 and 10 and the electrolysis vessel 1 excluding an electrode base end portion coupled to the contact electrode 11. Thus, the convection in the electrolysis vessel 1 is more easily performed in cooperation with an action of the air bubble removing device, and thus it is possible to more efficiently perform the electrolysis.

According to the electrolysis described above, it is possible to decrease a concentration of the hardness component in the generated functional water, and the obtained functional water is used in an air spray type humidifying device, and thus it is possible to prevent a calcium salt or a magnesium salt from being attached to house furnishings or window glass. In addition, the functional water is used in a heating type humidifying device, and thus it is possible to prevent the hardness component from being accumulated in a humidifying filter or the like as a scale.

It is preferable that the pH of the functional water is greater than or equal to 2.5 and less than or equal to 5.0. The functional water is atomized in the diffusion unit 2, and thus it is possible to spray the functional water into the air or onto a human body without a fluctuation in the pH of the functional water, and when the functional water is sprayed into the air, it is possible to prevent bacterial infection by a sterilizing effect of the acidic functional water. When the functional water is sprayed onto the skin or the like, a sterilization effect due to an astringent effect, activation of the skin or the like, and a tightening effect of the skin are obtained. Furthermore, mist M, for example, is able to be generated by using an ultrasonic vibrator or the principle of spraying due to an air pump.

In addition, by using a steam generation device in the diffusion unit 2, the pH of the functional water is slightly shifted to a neutral side by boiling the water, the functional water as a base becomes water in which the hardness component is decreased by the electrolysis, and thus accumulation of the hardness component (a scale) in the vicinity of an ejection port which is problematic at the time of using the tap water as steam is prevented, and it is possible to prevent an occurrence of trouble in which the ejection port is clogged and thus does not eject the mist.

Accordingly, even when only the tap water is used, a user merit in that the steam is able to be sprayed for a long period of time is obtained without special maintenance. Of course, by spraying the steam, a humidifying effect in the air, and an improvement in moisture of the skin due to hot steam at the time of spraying the mist onto the skin or the like are obtained. Furthermore, in order to generate the steam, it is necessary to boil the water, and for example, the water may be boiled by a heater such as a ceramic heater all at once, or may be boiled by being heated in a plurality of stages. Furthermore, a water sprinkling tank may be any one of a mist generating tank or a steam generating tank, and in addition, both of the tanks may be included.

Furthermore, it is preferable that the water in any one of the electrolysis vessel 1 and the diffusion unit 2 does not include base metal (here, as the base metal, for example, platinum, gold, palladium, rhodium, iridium, or the like other than metal which is stable with respect to the functional water which is acidic water). This is because when a metal material such as iron or copper exists in a flow passage of the functional water, an oxidation-reduction reaction occurs between the metal material and the functional water, and thus the pH of the functional water is neutralized, and the functional water having a desired pH is not obtained. Accordingly, in the heaters described above, the ceramic heater formed of a material which rarely reacts with the functional water is preferable.

The control device 14 ends the electrolysis when a predetermined amount of currents flows through the water in the electrolysis vessel 1, and opens the switching valve 7, and thus the generated functional water is introduced into the diffusion unit 2 through the discharge unit 3. In the diffusion unit 2, a device which converts the functional water into the mist or the steam is disposed, and the driving of the device is initiated by the control device 14, and thus the functional water is diffused into the air in a state of the mist M or the steam.

On the other hand, in the electrolysis vessel 1 after most of the functional water is discharged, the functional water having an amount in which the entirety of electrodes 9 and 10 are immersed remains. That is, the water drain port 15 is formed to have a height of the remaining functional water in which the entirety of electrodes 9 and 10 are immersed, and the functional water having an amount by which the switching valve 7 is opened remains.

In the electrolysis vessel 1, as illustrated in FIG. 4, a current flows in a direction opposite to that of the electrolysis by the control device 14 in a state where the electrodes 9 and 10 are immersed in the functional water, and thus the electrode is cleaned. In this case, the carbon electrode 10 is the positive electrode, and the platinum electrode 9 is the negative electrode. Accordingly, in the carbon electrode 10 which is the positive electrode, a hardness component M attached to the electrode surface is eluted into the water as M² as shown in the following reaction formula (3).

M→M²⁺+2e⁻ Formula (3)

On the other hand, in the surface of the platinum electrode which is the negative electrode, a reaction shown by the following reaction formula (4) occurs, and hydrogen gas (H₂) and hydroxide ions (OH⁻) are generated. That is, it is possible to convert the remaining water into alkali water by the reaction described above, and it is possible to elute the hardness component such as Ca ions or Mg ions which are adsorbed onto the carbon electrode. Furthermore, here, a current value applied into the remaining water does not depend on a remaining amount of the functional water, an electric quantity identical to that at the time of generating the functional water described above may flow, and for example, the current value may be 500 mA for 4 minutes, may be 250 mA for 8 minutes, or the like.

In this embodiment, the electrolysis, the drainage of the functional water, and the electrode cleaning are automatically performed by the control device 14. Accordingly, it is possible to increase convenience for the user, and it is possible to automatically maintain the electrode in an excellent state. In addition, the drainage of the functional water and the electrode cleaning may be manually performed after the electrolysis.

2H₂O+2e⁻→H₂↑+2OH⁻ Formula (4)

A pair or more of positive electrodes and negative electrodes may be used, and for example, the positive electrode and the negative electrode may be alternatively arranged in the vertical direction having a set distance. In addition, the hardness component of the carbon electrode may be eluted whenever the functional water is generated in the electrolysis vessel, or the hardness component of the carbon electrode may be eluted after the functional water is generated five to ten times. In addition, the discharge unit 3 is disposed to be detachable in midstream. As illustrated in FIG. 1, only when the discharge unit 3 is integrally coupled, that is, only when the electrolysis vessel 1 is mounted on the main body unit 5, the water is able to be discharged from the water drain port 15. In contrast, as illustrated in FIG. 3 and FIG. 4, when the discharge unit 3 is detached, that is, when the electrolysis vessel 1 is detached from the main body unit 5, a valve by which the water is not discharged is preferably used.

In addition, as the water used for the electrolysis of the electrolysis unit 4 described above, tap water is preferably used. This is because the hardness component such as Ca ions or Mg ions is included in the tap water in advance and contributes to ion conduction, and thus it is possible to perform the electrolysis at a comparatively low voltage. Accordingly, even when a comparatively low voltage value is used, it is possible to perform the electrolysis at a low voltage (low power) by usual tap water, and it is possible to decrease the running cost of the user. In a region where an amount of a dissolved hardness component is comparatively low, for convenience, a trace amount (approximately 0.1 wt % to 1 wt %) of an electrolysis additive agent such as KCl or NaCl may be added.

Furthermore, in this embodiment, the electrolysis is performed by using the platinum electrode as the positive electrode, and thus the functional water is generated. The electrode used in the positive electrode may be an electrode member which is not dissolved, or may be carbon or the like, metal which easily and efficiently performs the electrolysis of the water, for example, any one metal of platinum, gold, palladium, rhodium, and iridium (or an alloy thereof) is preferable, and for example, the surface of the electrode formed of titanium may be coated with platinum.

In the functional water generator having the configuration described above, the water into which the hardness component after the electrode cleaning is eluted may be removed by the user before the subsequent functional water is generated, or the water may be removed immediately before the subsequent use and a new solution may be supplied, and it is preferable that the water is removed after every use of the water in order to prevent the hardness component from being attached to the electrode again.

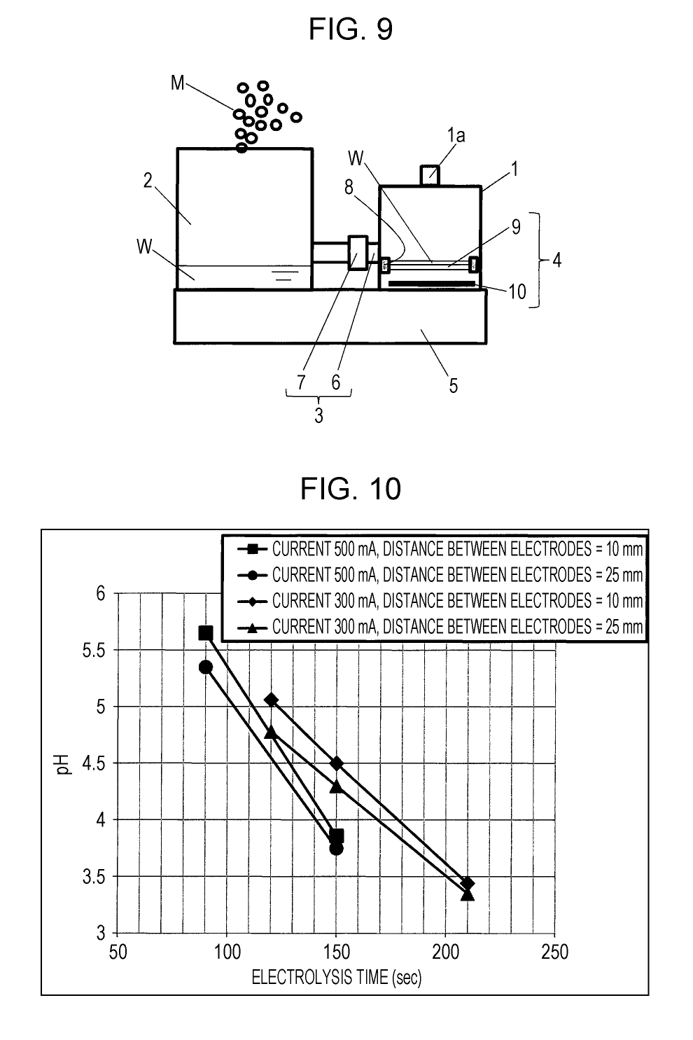

FIGS. 8 and 9 are diagrams illustrating a second embodiment of the present invention, FIG. 8 illustrates a schematic view of the functional water generator in a state where the electrolysis vessel is filled with the water, and FIG. 9 illustrates a schematic view of the functional water generator in a state where the functional water generated by the electrolysis is introduced into the diffusion unit. In this embodiment, the functional water generator has the same configuration as that of the functional water generator in FIG. 1 except that a float is attached to the platinum electrode 9.

In the functional water generator of this embodiment, a float 8 is attached to an end portion of the platinum electrode 9 as the positive electrode in the electrolysis vessel 1, and thus the position of the platinum electrode 9 is movable in the up and down direction following a solution level. That is, as illustrated in FIG. 8, when the water contained in the electrolysis vessel 1 is electrolyzed, the platinum electrode 9 rises to an upper portion of the electrolysis vessel 1 following the water surface, and the functional water is generated by electrolyzing the entirety of obtained water.

When the functional water is drained from the water drain port 15, as illustrated in FIG. 9, the platinum electrode 9 is lowered following the water surface of the functional water. Then, a current in a direction opposite to that at the time of generating the functional water is applied to the water remaining in the electrolysis vessel 1, and thus it is possible to elute and remove the hardness component which is adsorbed onto the activated carbon electrode to the maximum amount at the time of generating the functional water by using the minimum amount of water.

FIG. 10 compares generating times of the functional water when a set distance between the electrodes is actually changed (an electrolysis condition: a current of 300 mA and 500 mA is applied to 300 mL of water in an electrode size: 90 mm×70 mm, and a set distance between electrodes: 10 mm).

Comparing a time that is required for generating the functional water having, for example, a pH of 4.5 (a set distance between electrodes: 25 mm, and an electrode position=3 mm below the solution level) when the positive electrode is movable following the water surface with a time when the positive electrode is fixed (a set distance between electrodes: 10 mm), in a case where a current of 500 mA is applied, time shortening of approximately 8 seconds is observed, and in a case where a current of 300 mA is applied, time shortening of approximately 12 seconds (approximately 6% to 8%) is observed depending on a current value. It is considered that this is mainly because, the hydrogen ions generated at the time of generating the functional water are able to be diffused only in a down direction of the platinum electrode, and thus the hydrogen ions generated in the positive electrode are able to be involved in conduction between the positive electrode and the negative electrode and to decrease a voltage (increase electric conductivity), and according to this, efficiency of the electrolysis is able to be improved.

Thus, it is possible to reduce the electrolysis time by movement of the positive electrode following the water surface. In addition, it is possible to elute and remove the hardness component which is adsorbed onto the activated carbon electrode to the maximum amount at the time of generating the functional water by using the minimum amount of water. Furthermore, the positive electrode may be moved following a change in the water level such that the positive electrode is positioned on a lower side from the water surface by 1 mm to 10 mm. It is preferable that the float is formed of a flat member to be movable in the up and down direction while sliding along a wall surface of the electrolysis vessel. In addition, as a current value to be applied increases, a time to be shortened becomes shorter. On the other hand, a lifetime of the electrode is shortened, and thus it is preferable that a current density is less than or equal to 120 A/m².

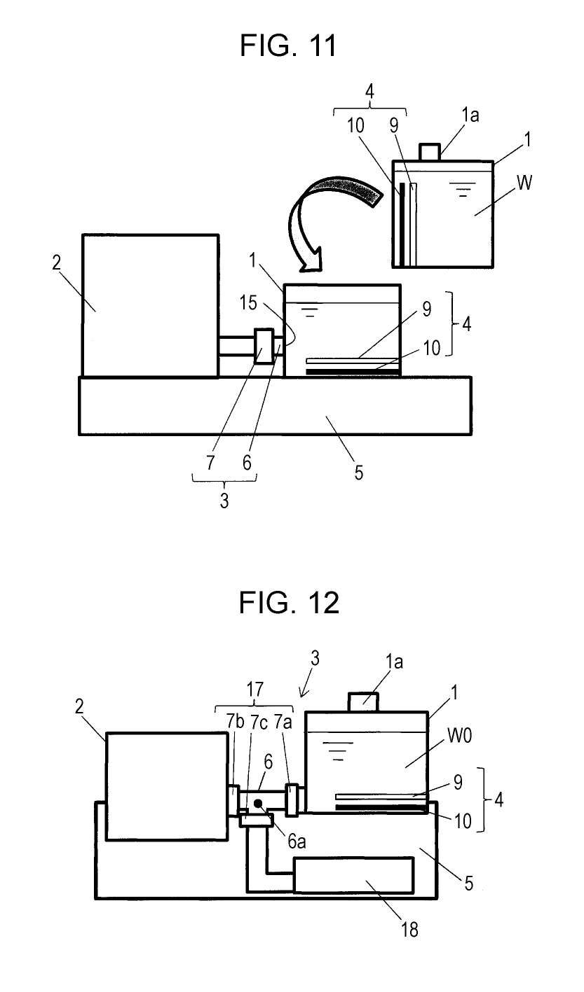

FIG. 11 is a schematic view for illustrating a third embodiment of the present invention. In this embodiment, when the electrolysis vessel 1 is detached from the main body unit 5 by separating the discharge unit 3, the water drain port 15 is automatically closed. Furthermore, the water drain port 15 is disposed to be manually openable, and functions as the water supply port 1a at the time of supplying the water.

That is, the water drain port 15 at the time of supplying the water is directed upward and manually opened, and then functions as the water supply port 1a, and thus the water W is supplied into the electrolysis vessel 1. As the water W, usual tap water is able to be used. After the electrolysis vessel 1 is filled with the water, the electrolysis vessel 1 returns to an original state (a state where the water drain port 15 is directed sideways), and thus is mounted on the main body unit 5. In order to obtain electric contact at the time of being attachable and detachable, a contact point is disposed on both the electrolysis vessel 1 side and the main body unit 5 side, and thus electric contact is obtained.

By mounting the electrolysis vessel 1 on the main body unit 5, that is, the water drain port 15 is opened in a state where the discharge unit 3 is integrally coupled, and the switching of the discharge unit 3 is controlled by the switching of the switching valve 7. Furthermore, power is supplied to the electrolysis vessel 1 from the main body unit 5, and the electrolysis is initiated. By performing the electrolysis for approximately 1 minute to 3 minutes, the functional water having a pH of approximately 2.5 to 5.0 is generated.

After completing the electrolysis, by switching the switching valve 7 disposed on a main body of the functional water generator into “OPEN”, the functional water generated in the electrolysis vessel 1 is introduced into the main body unit 5 through the discharge unit 3. (After the functional water is introduced into the main body of the functional water generator, a current in a reverse direction is applied into the electrolysis vessel, and thus it is possible to elute and remove the hardness component attached to the activated carbon electrode in the remaining water).

That is, in this embodiment, the water drain port is directed upward at the time of supplying the water and functions as the water supply port, and thus the positive electrode and the negative electrode of the electrolysis unit are in the erected state, and it is possible to perform stable water supply in which the water is rarely spilt due to hand shaking or the like. In addition, after cleaning the electrode, in the state where the electrolysis vessel is detached from the main body unit, the water drain port is directed downward and functions as a waste water port when remaining water in which the hardness component is dissolved is removed. At this time, the positive electrode and the negative electrode of the electrolysis unit are in the erected state, and the remaining water is directed toward the water drain port and flows along the electrode surface, and thus it is possible to effectively remove the hardness component which is still attached to the electrode surface.

FIG. 12 to FIG. 15 are diagrams for illustrating a fourth embodiment of the present invention. In this embodiment, the functional water generator has the same configuration as that of the first embodiment except that a functional water storage unit storing functional water W1 generated by electrolysis, and an alkali water storage unit storing alkali water generated by electrode cleaning are separately formed, and the pipe 6 of the discharge unit 3 is coupled to a bottom portion of the electrolysis vessel 1.

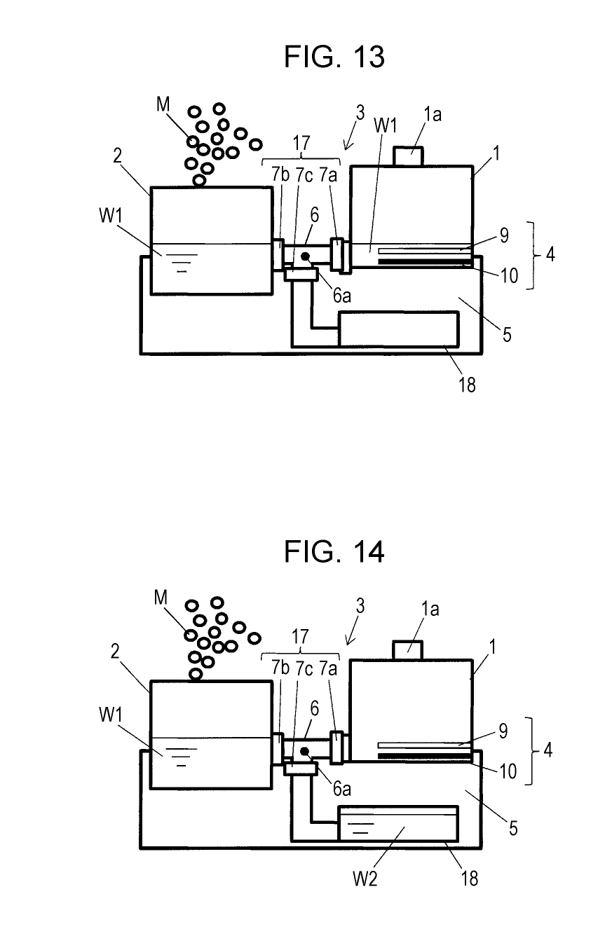

FIG. 12 is a diagram illustrating a configuration of the functional water generator of this embodiment, and a schematic view illustrating a state where the water is supplied into the electrolysis vessel. Furthermore, in this embodiment, the diffusion unit 2 of the first embodiment functions as the functional water storage unit storing the functional water. FIG. 13 is a schematic view illustrating a state where the functional water generated in the functional water generator of FIG. 12 is drained from the electrolysis vessel and is introduced into the functional water storage unit (=the diffusion unit). FIG. 14 is a schematic view illustrating a state where the electrode is cleaned by using the functional water remaining in the electrolysis vessel of the functional water generator of FIG. 13, and the generated alkali water is introduced into the alkali water storage unit.

The functional water generator of this embodiment includes a functional water storage unit (=the diffusion unit) 2 storing the functional water W1 which is generated by electrolyzing water W0, and an alkali water storage unit 18 storing alkali water W2 which is generated by cleaning the electrode. Furthermore, the alkali water storage unit 18 is detachably attached to the main body unit 5. The discharge unit 3 is formed to discharge the functional water W1 or the alkali water W2 from the electrolysis vessel 1, and to introduce the functional water W1 or the alkali water W2 into the functional water storage unit 2 or the alkali water storage unit 18.

Specifically, one end side of the discharge unit 3 is coupled to the electrolysis vessel 1, and the other end side thereof is configured of the pipe 6 which is branched through a branched portion 6a, and a flow passage switching member 17 which is disposed through the pipe 6, and the functional water storage unit 2 and the alkali water storage unit 18 are coupled to the other end side of the pipe 6. One end side of the pipe 6 is coupled to a bottom portion of the electrolysis vessel 1. The flow passage switching member 17 includes a switching valve 7a which is disposed through the pipe between the branched portion 6a and the electrolysis vessel 1, a switching valve 7b which is disposed through a pipe between the branched portion 6a and the functional water storage unit 2, and a switching valve 7c which is disposed through a pipe between the branched portion 6a and the alkali water storage unit 18. The control device 14 controls the switching of the respective switching valves 7a to 7c of the flow passage switching member 17 and the driving of a mist generation device.

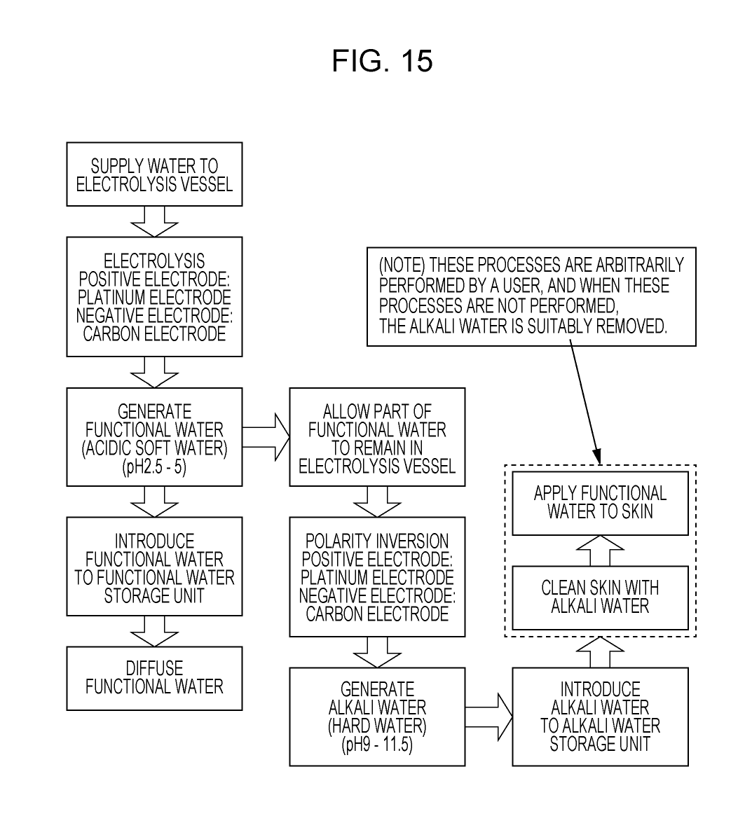

An operation of the functional water generator having the configuration described above will be described. FIG. 15 is a diagram for illustrating schematic operation contents of the functional water generator of this embodiment. First, similar to the first embodiment, the control device 14 performs the electrolysis of the water in the electrolysis vessel 1. Then, the electrolysis is ended when a predetermined amount of currents flow through the water, and the switching of the switching valves 7a to 7c of the flow passage switching member 17 is controlled, and thus as illustrated in FIG. 13, the generated functional water W1 is introduced into the functional water storage unit 2 through the discharge unit 3. Specifically, in a state where the switching valve 7c is closed, the switching valves 7a and 7b are opened.

Accordingly, in a state where the flow passage between the electrolysis vessel 1 and the alkali water storage unit 18 is closed, the flow passage between the electrolysis vessel 1 and the functional water storage unit 2 is opened, and the functional water W1 in the electrolysis vessel 1 flows into the functional water storage unit 2 until the height of the functional water W1 in the functional water storage unit 2 is identical to that of the water surface. At this time, the position and the size of the functional water storage unit 2 may be adjusted such that the functional water W1 having an amount in which both the entire electrodes 9 and 10 of the electrolysis unit are immersed remains in the electrolysis vessel.

Accordingly, even when the switching valves 7a and 7b are opened, and the water W in the electrolysis vessel 1 is drained from the discharge unit 3, as illustrated in FIG. 13, maintained in a state where the entire platinum electrode 9 and the entire carbon electrode 10 are maintained in a state of being immersed in the water W. The functional water storage unit 2 is originally the diffusion unit, and thus the functional water W1 contained therein is atomized by the control device 14 and is diffused into the air.

As described above, a current having an electric quantity to the same extent as that at the time of generating acidic water in a direction opposite to that at the time of performing the electrolysis, and thus the control device 14 cleans the electrode. Furthermore, in order to reliably manage pH of the alkali water, it is preferable that a pH sensor, a conductivity sensor, or the like is disposed in the functional water storage unit to perform monitoring. Furthermore, it is preferable that pH of the alkali water W2 is greater than or equal to 9.0 and less than or equal to 11.5.

After the electrode cleaning is ended, the switching valves 7a and 7c are opened in a state where the switching valve 7b is closed. At this time, a bottom surface of the alkali water storage unit 18 is lower than a bottom surface of the electrolysis vessel 1, and thus even when a pump or the like is not used, it is possible to introduce the alkali water W2 into the alkali water storage unit 18 from the electrolysis vessel 1 by using a gravity force. The alkali water W2 stored in the alkali water storage unit 18 may be used for face cleaning, or may be removed when an amount of the alkali water W2 accumulated in the alkali water storage unit 18 increases.

When the alkali water W2 is used for skin cleaning, a so-called saponification reaction as shown in the following reaction formula (5) occurs between hydroxide ions (OH⁻) in the alkali water and fat and oil of a skin surface, and thus a surfactant action is obtained, and a cleaning effect is exerted. Thus, the alkali water W2 is effectively used, and thus it is possible to further increase convenience of the functional water generator. Furthermore, in the formula, Na⁺ indicates sodium ions existing on the skin.

R−COOCH₂CH(OOC—R)CH₂OOC—R+3Na⁺+OH⁻→C₃H₅(OH)₃+3R—COO—Na Formula (5)

In this embodiment, the platinum electrode 9 and the carbon electrode 10 are arranged to face each other in parallel in the vertical direction having a set distance, and thus when the entire platinum electrode 9 and the entire carbon electrode 10 are maintained in the state of being immersed in the functional water W1, it is possible to increase an amount of functional water which is discharged into the functional water storage unit 2. That is, it is possible to increase an amount of functional water W1 which is able to be used.

Further, it is possible to suppress an amount of alkali water W2 which is able to be generated by the electrode cleaning, and it is possible to store the alkali water W2 in the alkali water storage unit 18 for a plurality of electrode cleanings. Therefore, it is possible to save time of ejecting the alkali water W2 remaining in the electrolysis vessel whenever the electrode is cleaned, and it is possible to obtain the functional water generator having high convenience.

As it is obvious from the description of the embodiments, a functional water generating device of the present invention is provided with the electrolysis unit including the positive electrode and the negative electrode in the electrolysis vessel, the functional water is generated by performing the electrolysis with respect to the water supplied to the electrolysis vessel in the electrolysis unit, then when the functional water is discharged from the electrolysis vessel, the functional water remains in the electrolysis vessel such that both the positive electrode and the negative electrode are immersed, and a current in a direction opposite to that at the time of generating the functional through the electrode of the electrolysis unit, and thus the hardness component attached to the electrode at the time of generating the functional water is eluted into the water and the electrode is cleaned. In the functional water generating device of the present invention, the functional water storage unit storing the functional water which is generated by the electrolysis, and the alkali water storage unit storing the alkali water which is generated by the electrode cleaning are formed separately from the electrolysis vessel.

According to such a configuration, the functional water which is generated by the electrolysis in the electrolysis vessel is stored in the functional water storage unit, and the alkali water which is generated by the electrode cleaning is stored in the alkali water storage unit, and thus it is possible to save the time of ejecting the alkali water remaining in the electrolysis vessel whenever the electrode is cleaned, and it is possible to obtain the functional water generator having high convenience.

In order to store the alkali water in the electrolysis vessel in the alkali water storage unit, the discharge unit discharging the alkali water into the electrolysis vessel may be disposed, and the alkali water storage unit may be coupled to the discharge unit. Furthermore, it is possible to form the discharge unit separately from the discharge unit discharging the functional water, and the discharge unit may discharge the functional water and the alkali water.

The discharge unit discharging the functional water and the alkali water from the electrolysis vessel, specifically, includes the pipe of which the one end side is coupled to the electrolysis vessel and the other end side is branched through the branched portion, and the flow passage switching member which disposed through the pipe, and the functional water storage unit and the alkali water storage unit storing the alkali water which is generated after the electrode cleaning are able to be coupled to the other end side of the pipe. Accordingly, it is possible to simplify a structure of the entire functional water generator.

In the discharge unit having the configuration described above, the one end side of the pipe is coupled to the bottom portion of the electrolysis vessel, the water supplied to the electrolysis vessel is electrolyzed in the state where the discharge unit is closed, then when the flow passage between the electrolysis vessel and the functional water storage unit is opened in a state where the flow passage between the electrolysis vessel and the alkali water storage unit is closed by the flow passage switching member, the position of the functional water storage unit may be set such that the functional water having an amount in which the both entire electrodes of the electrolysis unit are immersed remains in the electrolysis vessel.

According to the configuration described above, the functional water having an amount which is necessary for the electrode cleaning is able to remain in the electrolysis vessel only by switching the flow passage using the flow passage switching member. Furthermore, specifically, when the functional water storage unit having an arbitrary size is used for setting the position of the functional water storage unit, the height of the water surface of the functional water in the electrolysis vessel may be balanced with the height of the water surface of the functional water storage unit at a height where the both entire electrodes of the electrolysis unit are immersed by adjusting the position (the height) when the flow passage between the electrolysis vessel and the functional water storage unit is opened in a state where the flow passage between the electrolysis vessel and the alkali water storage unit is closed.

Further, in the discharge unit described above, in addition to the configuration described above, the electrode is cleaned, then when the flow passage between the electrolysis vessel and the alkali water storage unit is opened by the flow passage switching member in the state where the flow passage between the electrolysis vessel and the functional water storage unit is closed, the position of the alkali water storage unit may be set such that the alkali water in the electrolysis vessel flows into the alkali water storage unit.

Specifically, the bottom surface of the alkali water storage unit is adjusted to be lower than the bottom surface of the electrolysis vessel. Preferably, the entire alkali water storage unit is adjusted to be positioned lower than the bottom surface of the electrolysis vessel. Accordingly, even when a pump or the like is not used, it is possible to introduce the alkali water into the alkali water storage unit from the electrolysis vessel by using a gravity force.

The positive electrode and the negative electrode of the electrolysis unit may be arranged to face each other in parallel in the vertical direction. Accordingly, the thickness direction of the electrode is the vertical direction, and thus a volume of the electrolysis vessel occupied by the electrolysis unit decreases compared to a case where the electrode is erected. Therefore, when the electrode is cleaned, it is possible to decrease an amount of remaining functional water. Accordingly, it is possible to decrease an amount of alkali water which is generated in one electrode cleaning, and it is possible to reduce labor of removing the alkali water accumulated in the alkali water storage unit.

When the obtained alkali water is used for the skin cleaning, as described above, a saponification reaction occurs between the hydroxide ions (OH⁻) in the alkali water and fat and oil of the skin surface, and a reaction product has a surfactant action, and thus a cleaning effect is exerted. Thus, the alkali water is effectively used, and thus it is possible to further increase convenience of the functional water generator.

When the alkali water is applied to the skin from the alkali water storage unit, the alkali water may be directly applied to the skin in a liquid state, or may be locally sprayed onto the skin in a mist state. Furthermore, it is preferable that the functional water is applied to the skin after the skin cleaning is performed by the alkali water. That is, in a state where the skin cleaning is performed by the alkali water and pH of the skin tends to be alkaline, various germs easily propagate on the skin. Therefore, the functional water is finally applied to the skin, and thus it is possible to suppress the propagation of the various germs on the skin by making the pH of the skin acidic.

As described above in detail, when the functional water obtained by the functional water generator of the present invention is applied to the skin, it is preferable that only the functional water is applied to the skin without performing the skin cleaning by the alkali water, or when the skin cleaning is performed by the alkali water, it is preferable that the functional water is applied to the skin after that.

As described above, the embodiments of the present invention are described, but the range of the present invention is not limited thereto, and the present invention is able to be variously changed without deviating from the gist of the invention. For example, in this embodiment, the platinum electrode 9 is arranged on the upper side than the carbon electrode 10, but the present invention is not limited thereto, and as illustrated in FIG. 6, the carbon electrode 10 is able to be arranged on the upper side than the platinum electrode 9. Accordingly, when the vessel including the electrolysis unit therein is cleaned, it is possible to more directly clean the carbon electrode by the cleaning water.

A plenty of hardness components in the water are attached to a surface of the activated carbon surface facing the platinum electrode, and thus when the electrolysis vessel is cleaned by the cleaning water such as tap water, it is possible to effectively clean the activated carbon surface by directly applying water pressure from the cleaning water to the carbon electrode, and thus it is possible to more effectively clean the remaining alkali water component and the remaining hardness component.

In addition, by arranging the carbon electrode on the upper side than the platinum electrode, the entire electrolyzed water passes through the carbon electrode, and thus it is possible to adsorb a dust component in the water such as nanoparticles by an adsorption action of the carbon electrode, and it is also possible to purify the water. Furthermore, in order to effectively clean the carbon electrode by the cleaning water, it is preferable that the carbon electrode is as porous as possible, and is preferable that the thickness is less than or equal to 4 mm.

Furthermore, in order to more efficiently perform the electrolysis, it is possible to make gas difficult to be accumulated by disposing a slit in the platinum electrode, by arranging a plurality of stripe-like platinum electrode in the horizontal direction having a set distance, or by forming a mesh-like platinum electrode, and it is possible to effectively perform convection with respect to acid-alkali ions generated on the platinum electrode in an upper portion and a lower portion of the platinum electrode.

In addition, in this embodiment, as the flow passage switching member 17, the switching valves 7a to 7c are used, but the present invention is not limited thereto, and for example, a three-way valve may be disposed in the branched portion 6a. Further, in this embodiment, the position of the functional water storage unit 2 and the alkali water storage unit 18 is set on the basis of the position of the electrolysis vessel 1, and the switching of the switching valves 7a to 7c is controlled, and thus the functional water W1 and the alkali water W2 are introduced to the functional water storage unit 2 and the alkali water storage unit 18 by using a gravity force, but the present invention is not limited thereto, and for example, a water amount detection sensor may be disposed in the electrolysis vessel 1, and a predetermined amount of functional water W1 and alkali water W2 may be discharged by a pump.

In addition, the hardness component (a scale) is easily precipitated in the alkali water storage unit 18, and various germs also easily propagate, and thus it is also preferable that a mode is suitably disposed in which the acidic water is introduced to the alkali water storage unit 18 from the functional water storage unit 2, and the scale is eluted and sterilized.

### REFERENCE SIGNS LIST

1 ELECTROLYSIS VESSEL
2 DIFFUSION UNIT
3 DISCHARGE UNIT
4 ELECTROLYSIS UNIT
5 MAIN BODY UNIT
6 PIPE
7 SWITCHING VALVE
8 FLOAT
9 PLATINUM ELECTRODE
10 CARBON ELECTRODE
11 CONTACT ELECTRODE
12 SWITCHING CIRCUIT
13 CONSTANT CURRENT GENERATION SOURCE
14 CONTROL DEVICE
15 WATER DRAIN PORT
17 FLOW PASSAGE SWITCHING MEMBER
18 ALKALI WATER STORAGE UNIT

1. A functional water generator, comprising:
an electrolysis unit which is formed of a positive electrode and a negative electrode, and is disposed in an electrolysis vessel,
wherein the electrolysis unit electrolyzes water supplied into the electrolysis vessel and generates functional water, then when the functional water is discharged from a water drain port of the electrolysis vessel, the functional water remains in the electrolysis vessel such that both of the positive electrode and the negative electrode are immersed, and a current flows through the electrodes of the electrolysis unit in a direction opposite to that at the time of generating the functional water, and thus electrode cleaning is performed in which a hardness component attached to the electrodes at the time of generating the functional water is eluted into the water, and
the positive electrode and the negative electrode are arranged to face each other in parallel in a vertical direction.

2. The functional water generator according to claim 1,
wherein the positive electrode of the electrolysis unit is arranged above the negative electrode.

3. The functional water generator according to claim 2,
wherein the positive electrode is movable in an up and down direction following a water surface in the electrolysis vessel.

4. The functional water generator according to claim 3,
wherein a float is attached to the positive electrode of the electrolysis unit.

5. The functional water generator according to claim 1,
wherein the negative electrode of the electrolysis unit is arranged above the positive electrode.

6. The functional water generator according to claim 1,
wherein an air bubble removing device removing air bubbles attached to the electrolysis unit is disposed in the electrolysis vessel.

7. The functional water generator according to claim 1,
wherein in the electrolysis vessel, end portions of the positive electrode and the negative electrode excluding an electrode base end portion are separated from an inside wall of the electrolysis vessel by greater than or equal to 5 mm.

8. The functional water generator according to claim 1, further comprising:
a diffusion unit which ejects the functional water discharged from the water drain port into the air in the shape of mist or steam.

9. The functional water generator according to claim 1,
wherein base metal is not included in any water in the electrolysis vessel and a diffusion unit.

10. The functional water generator according to claim 1, further comprising:
a main body unit which retains the electrolysis vessel to be attachable and detachable,
wherein the water drain port functions as a water supply port for supplying water into the electrolysis vessel in a state in which the electrolysis vessel is detached from the main body unit.

11. The functional water generator according to claim 8,
wherein the functional water generator is used for air cleaning or humidifying.

12. The functional water generator according to claim 1,
wherein the functional water generator is used for aesthetics.
